(19) United States
(12) Patent Application Publication
(10) Pub. No.: US 2010/0200503 A1
(43) Pub. Date: Aug. 12, 2010

(54) CLEANING METHOD FOR SIMPLE FILTRATION SYSTEMS

(76) Inventors: Fufang Zha, New South Wales (AU); Zhiyi Cao, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/666,640

(22) PCT Filed: Jun. 25, 2008
(86) PCT No.: PCT/AU2008/000925

§ 371 Date: Dec. 23, 2009

(30) Foreign Application Priority Data
Jun. 28, 2007 (AU) 2007903497

(51) Int. Cl. B01D 65/02

(52) U.S. Cl. 210/636; 210/409; 210/321.69

(57) ABSTRACT

A method of cleaning a permeable, hollow membrane (6) in an arrangement of the type wherein a pressure differential is applied across the wall of the permeable, hollow membrane (6) immersed in a liquid suspension provided in a vessel (5), said liquid suspension being applied to the outer surface of the permeable hollow membrane (6) to induce and sustain filtration through the membrane wall. The method of cleaning comprising the steps of: suspending the filtration process; while continuing to supply the liquid suspension to the vessel (5); aerating the membrane (6) by flowing gas into the vessel (5) to produce a flow of gas bubbles around the membrane (6) to dislodge at least some of the retained particulate material from the membrane surface; removing liquid containing dislodged particulate material from the vessel (5) during the aerating step and recommencing the filtration process.

### TECHNICAL FIELD

The present invention relates to membrane filtration systems, and more particularly, to a simple, low cost filtration system which may be used in remote, underdeveloped regions of the world or in locations where normal infrastructure has been damaged or destroyed by a natural or man-made disaster. The invention particularly relates to membrane cleaning arrangement for such filtration systems.

### BACKGROUND OF THE INVENTION

In many areas of developing countries, clean drinking water is a scarcity. Also for the more remote regions electricity is not available. In such regions the use of expensive, energy intensive water filtration systems is impractical. Filtration systems employing porous membranes have been in use for many years, however, these systems require expensive equipment and complex pumping, valve and cleaning systems. The expense is usually justified where a large-scale system is employed servicing a large community.

In poorer developing countries and/or in remote locations where economies of scale are not possible and ready access to electricity is limited or non-existent, there is a need for a simple, low cost filtration system which can deliver high quality drinking water on a small or limited scale such as a single farm house or a small rural village.

There is a need for a simple efficient membrane cleaning system for such filtration systems to ensure the membranes can operate efficiently for prolonged periods.

### SUMMARY OF THE INVENTION

It is an object of the present invention to overcome or ameliorate at least one of the disadvantages of the prior art, or to provide a useful alternative.

According to one aspect, the present invention provides a method of cleaning a permeable, hollow membrane in an arrangement of the type wherein a pressure differential is applied across the wall of the permeable, hollow membrane immersed in a liquid suspension provided in a vessel, said liquid suspension being applied to the outer surface of the permeable hollow membrane to induce and sustain filtration through the membrane wall wherein:
(a) some of the liquid suspension passes through the wall of the membrane to be drawn off as clarified liquid or permeate from the hollow membrane lumen, and
(b) at least some of the solids are retained on, or in, the hollow membrane or otherwise as suspended solids within the liquid surrounding the membrane,
   the method of cleaning comprising the steps of;
(i) suspending said filtration; while continuing to supply said liquid suspension to said vessel;
(ii) aerating the membrane by flowing gas into said vessel to produce a flow of gas bubbles around said membrane to dislodge at least some of the retained particulate material;
(iii) removing liquid containing dislodged particulate material from said vessel during said aerating step;
(iv) recommencing said filtration.

Preferably, filtration is suspended by ceasing drawing off of permeate from the membrane. For preference, the vessel is a closed vessel having an inlet and an outlet wherein the liquid suspension is supplied through the inlet and liquid containing dislodged particulate material is removed through the outlet. Preferably said outlet is closed during filtration.

In one form of this method, during the filtration process, the pressure differential is produced by supplying the liquid suspension to the vessel under force of gravity such that pressure is applied on the feed side of the membrane by gravity feed of liquid into the vessel and/or suction is applied to the membrane lumen/s by gravity flow therefrom.

In one embodiment, the aerating step is ceased while continuing the removal step.

In one embodiment, the method includes the step of removing, at least partially, liquid from the feed side of the membrane before and/or during the aerating step.

The invention includes, in other aspects, apparatus for performing the various methods described.

### BRIEF DESCRIPTION OF THE DRAWINGS

A preferred embodiment of the invention will now be described, by way of example only, with reference to the accompanying drawings in which:

FIG. 1 shows and simplified schematic cross-sectional side elevation of one embodiment of the invention; and

FIG. 2 shows a graph of filtrate flow over time for a manual cleaning process and a process according to an embodiment of the invention.

### DESCRIPTION OF PREFERRED EMBODIMENT

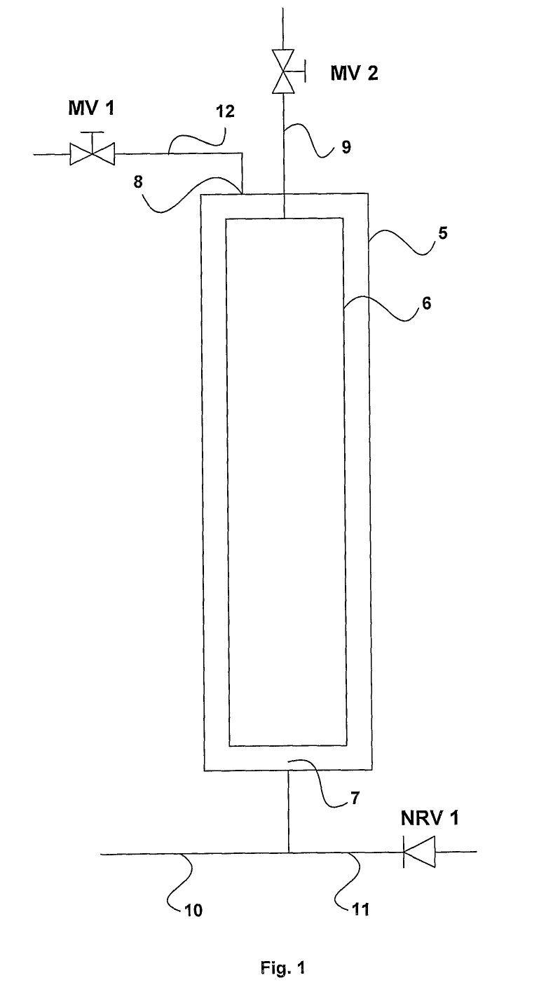

Referring to FIG. 1 of the drawings, the filtration system according to this embodiment includes a feed vessel 5 having a membrane filter 6 mounted therein. The membrane filter 6 is typically of the type wherein a pressure differential is applied across the wall of a permeable, hollow membrane or membranes immersed in a liquid suspension, the liquid suspension being applied to the outer surface of the permeable hollow membrane to induce and sustain filtration through the membrane wall wherein some of the liquid suspension passes through the wall of the membrane to be drawn off as clarified liquid or permeate from the hollow membrane lumen, and at least some of the solids are retained on, or in, the hollow membrane or otherwise as suspended solids within the liquid surrounding the membranes.

The feed vessel 5 is provided with an inlet port 7 and an outlet port 8. A filtrate line 9 is connected to the membrane filter 6 for removing filtrate from the membranes during filtration. The flow of filtrate through filtrate line 9 is controlled by manual valve MV1. The inlet port 7 is fluidly connected to a feed source through feed line 10 and a source of gas, typically air, through a gas supply line 11. The gas supply line 11 is provided with a non-return valve NRV1 to control gas flow to the inlet port 7. The outlet port 8 is connected to a waste line 12 through a manual valve MV1.

In the simplest form of this embodiment, only two manual valves, one Non-Return Valve and a low cost air blower are required for the operation of the unit. One example of a low cost air blower would be the vibrating diaphragm type air blower used for aerating fish tanks. In this simple arrangement, filtration can be produced by feeding the liquid into the feed vessel 5 under force of gravity such that pressure is applied on the feed side of the membranes by gravity feed of liquid into the vessel 5 and/or suction is applied to the membrane lumens by gravity flow therefrom.

In a slightly more sophisticated form, automatic valves may replace manual valves MV1 and MV2. A simple controller may be used to control the two automatic valves together with feed pump (if required) and the aeration blower or compressor. In such case, the filtration process and backwash process can be fully automated at low costs.

It will be appreciated than any suitable form of membrane filter device may be used, including hollow fibre membranes, tubular membranes and membrane mats. Similarly, any suitable form of aeration device may be used to provide gas bubbles within the feed vessel including a simple port in the vessel, spargers, diffusers, injectors and the like.

The operation of this embodiment will now be described with reference to FIG. 1 of the drawings.

### Filtration Process

During the filtration process, feed is supplied through the feed line 10 to the lower inlet port 7. Manual valve MV1 is closed to pressurise the vessel 5 and MV2 is opened to allow filtrate to flow from the membrane filter 6. To simplify the operation, the filter is generally operated with constant feed pressure/TMP mode. The feed pressure may be supplied either by gravity or a feed pump. However, the system may be operated with constant flow mode when a flow control valve is fitted to the feed line 10.

Typically, the system is designed to operate at a feed inlet pressure less than 50 kPa. However, in some cases, when used to supply to the household water system, the feed inlet pressure may be as high as 400 kPa.

### Membrane Cleaning Process

Over time, the filtration flow rate reduces due to fouling of the membrane.

Due to the low-pressure operation of the filtration process, the foulant formed on the filtrate side of the membrane can be easily removed. The membrane cleaning process is important in recover the filtration system performance.

The cleaning process typically involves following steps:

Step 1: Shell side sweeping with aeration, for period of about 5 seconds to about 180 seconds. During this step manual valve MV1 is opened to allow the flow of waste containing liquid from the feed vessel 5 and filtration is suspended by closing manual valve MV2. In some embodiments, MV2 may be left open during the cleaning process. Feed liquid continues to flow into the vessel 5 through feed line 10 connected to inlet port 7 and a shell side liquid sweep of the membrane filter 6 and the feed vessel 5 starts. Scouring air is then fed into the inlet port 7 via a blower or compressor (not shown) connected to the gas supply line 11 through non-return valve NRV1. It will be appreciated that gas could also be injected to the feed line 10. This is the main step of the membrane cleaning process. The turbulence generated by scouring air together with liquid sweep removes foulants from the membrane filter and recovers the membrane performance. In typical systems, the sweeping liquid flow rate ranges from is about 0.5 m³/hr to about 6 m³/hr and the scouring airflow rate ranges from about 1 Nm³/hr to about 20 Nm³/hr per module.

Step 2: Shell side sweeping for a period of about 10 seconds to about 300 seconds. During this step, manual valve MV2 remains closed while the scouring air source is disabled to stop the aeration but the shell side liquid sweep continues with the feed liquid continuing to flow into the feed vessel 5 through feed line 10. In some embodiments, MV2 may be opened during this step. This step serves to remove air bubbles trapped in shell side of the feed vessel 5 and further remove foulants dislodged by cleaning step 1 through outlet port 8 and waste line 12. Typically, the sweeping flow rate ranges from about 0.5 m³/hr to about 10 m³/hr per module for a period of 0 to 300 seconds.

Step 3: Manual valve MV1 is closed to re-pressurise the feed vessel 5 and manual valve MV2 is opened to allow resumption of filtration.

The simple membrane filtration system was tested and performance compared against a system using manual agitation for cleaning. The manual agitation process to remove foulant from the membranes comprised rotating or twisting the membrane filter within the feed vessel to produce a scouring flow of liquid across the membrane surfaces.

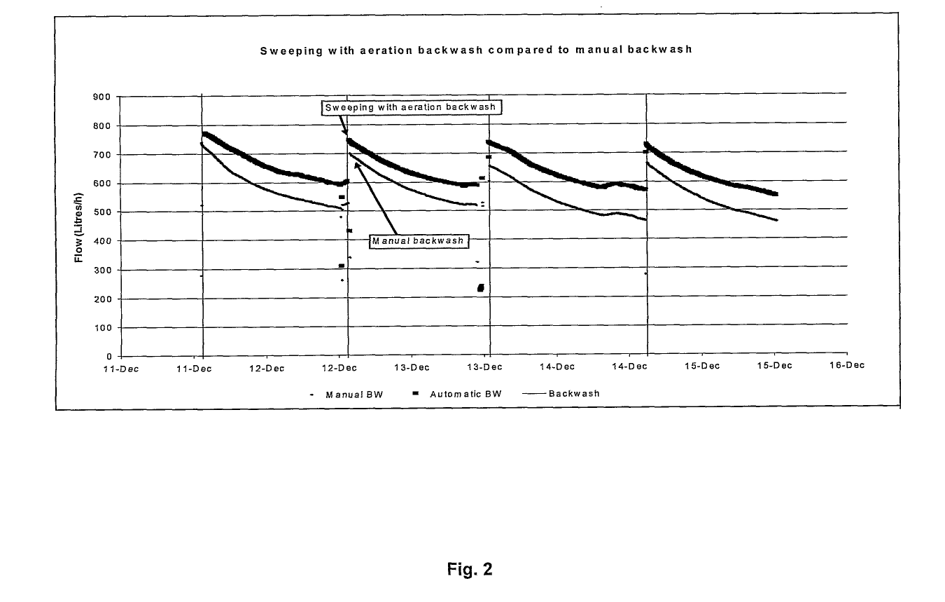

The results of the comparison are illustrated in the graph of FIG. 2. Both filter systems were operated at constant TMP mode while the feed pressure was supplied by the same gravity feed tank. For the manual agitation filtration system, the waste resulting from the membrane cleaning was drained from the vessel after the cleaning process.

From FIG. 2 it can be seen that the filter performance recovery for the sweeping with aeration cleaning process was higher than the manual agitation cleaning process. The daily filtrate production for each cleaning process is summarized in Table 1. As shown in Table 1, the daily filtrate production for the simple membrane filtration system with sweeping with aeration cleaning process is at least 10% higher than the filtration system with manual agitation cleaning process.

TABLE 1

| | Daily Filtrate | | |
|---|---|---|---|
| | Production - | Daily Filtrate | Productivity Improvement |
| | Sweeping with | Production - | Compared to Manual |
| | Aeration | Manual Cleaning | Cleaning Process |
| Day A | 373 | 338 | 10.3% |
| Day B | 326 | 297 | 10.0% |
| Day C | 378 | 333 | 13.6% |

It will be appreciated that further embodiments and exemplification of the invention are possible without departing from the spirit or scope of the invention described.

1. A method of cleaning a permeable, hollow membrane in an arrangement of the type wherein a pressure differential is applied across the wall of the permeable, hollow membrane immersed in a liquid suspension provided in a vessel, said liquid suspension being applied to the outer surface of the permeable hollow membrane to induce and sustain filtration through the membrane wall wherein:
(a) some of the liquid suspension passes through the wall of the membrane to be drawn off as clarified liquid or permeate from the hollow membrane lumen, and
(b) at least some of the solids are retained on, or in, the hollow membrane or otherwise as suspended solids within the liquid surrounding the membrane,
the method of cleaning comprising the steps of;
(i) suspending said filtration; while continuing to supply said liquid suspension to said vessel;
(ii) aerating the membrane by flowing gas into said vessel to produce a flow of gas bubbles around said membrane to dislodge at least some of the retained particulate material;
(iii) removing liquid containing dislodged particulate material from said vessel during said aerating step;
(iv) recommencing said filtration.

2. A method according to claim 1 wherein filtration is suspended by ceasing drawing off of permeate from the membrane.

3. A method according to claim 1 wherein the vessel is a closed vessel having an inlet and an outlet wherein the liquid suspension is supplied through the inlet and liquid containing dislodged particulate material is removed through the outlet.

4. A method according to claim 3 wherein said outlet is closed during filtration.

5. A method according to claim 1 wherein during the filtration process, the pressure differential is produced by supplying the liquid suspension to the vessel under force of gravity such that pressure is applied on the feed side of the membrane by gravity feed of liquid into the vessel and/or suction is applied to the membrane lumen/s by gravity flow therefrom.

6. A method according to claim 1 wherein the aerating step is ceased while continuing the removal step.

7. A method according to claim 1 wherein the method further includes the step of removing, at least partially, liquid from the feed side of the membrane before and/or during the aerating step.

8. A membrane filtration system comprising a permeable, hollow membrane in an arrangement of the type having means for applying a pressure differential across the wall of the permeable, hollow membrane immersed in a liquid suspension provided in a vessel, said liquid suspension being applied to the outer surface of the permeable hollow membrane to induce and sustain filtration through the membrane wall wherein:
(a) some of the liquid suspension passes through the wall of the membrane to be drawn off as clarified liquid or permeate from the hollow membrane lumen, and
(b) at least some of the solids are retained on, or in, the hollow membrane or otherwise as suspended solids within the liquid surrounding the membrane,
the filtration system comprising:
(i) means for suspending said filtration; while continuing to supply said liquid suspension to said vessel;
(ii) aeration means for aerating the membrane by flowing gas into said vessel to produce a flow of gas bubbles around said membrane to dislodge at least some of the retained particulate material;
(iii) means for removing liquid containing dislodged particulate material from said vessel during said aeration of the membrane;
(iv) and means for recommencing said filtration.

9. A system according to claim 8 wherein filtration is suspended by ceasing drawing off of permeate from the membrane.

10. A system according to claim 8 wherein the vessel is a closed vessel having an inlet and an outlet wherein the liquid suspension is supplied through the inlet and liquid containing dislodged particulate material is removed through the outlet.

11. A system according to claim 10 wherein said outlet is closed during filtration.

12. A system according to claim 8 wherein during the filtration process, the pressure differential is produced by supplying the liquid suspension to the vessel under force of gravity such that pressure is applied on the feed side of the membrane by gravity feed of liquid into the vessel and/or suction is applied to the membrane lumen/s by gravity flow therefrom.

13. A system according to claim 8 wherein the aeration is ceased while the continuing the removal of liquid containing dislodged particulate material.

14. A system according to claim 8 further including means for removing, at least partially, liquid from the feed side of the membrane before and/or during the aeration of the membrane.
